(19) United States
(12) Patent Application Publication
(10) Pub. No.: US 2010/0281192 A1
(43) Pub. Date: Nov. 4, 2010

(54) APPARATUS AND METHOD FOR TRANSFERRING DATA WITHIN A DATA PROCESSING SYSTEM

(75) Inventors: Shlomo Selim Rakib, Cupertino, CA (US); Marc Schaub, Sunnyvale, CA (US)

Correspondence Address: Stevens Law Group, 1754 Technology Drive, Suite #226, San Jose, CA, 95110, US

(73) Assignee: Novafora, Inc., San Jose, CA (US)

(21) Appl. No.: 12/433,822

(22) Filed: Apr. 30, 2009

(51) Int. Cl. G06F 5/14; H04L 9/32

(52) U.S. Cl. 710/52; 726/9

(57) ABSTRACT

An apparatus for transferring data between buffers within a data processing architecture includes first and second memory devices. The apparatus further includes a first connection manager associated with a first buffer in the first memory device, and a second connection manager associated with a second buffer in the second memory device. The first and second connection managers manage data transfers between the first and second buffers. The first connection manager is configured to receive a token from the second connection manager in order to trigger data transfer between the first buffer and the second buffer. The first connection manager is further configured to initiate a data transfer between the first and second buffers in response to receiving the token. This token-based method for initiating data transfers between the connection managers requires little or no CPU intervention.

### BACKGROUND

This invention relates to data processing, and more particularly to apparatus and methods for transferring data within a data processing system.

Signal and media processing (also referred to herein as “data processing”) is pervasive in today's electronic devices. This is true for cell phones, media players, personal digital assistants, gaming devices, personal computers, home gateway devices, and a host of other devices. From video, image, or audio processing, to telecommunications processing, many of these devices must perform several if not all of these tasks, often at the same time.

For example, a typical “smart” cell phone may require functionality to demodulate, decrypt, and decode incoming telecommunications signals, and encode, encrypt, and modulate outgoing telecommunication signals. If the smart phone also functions as an audio/video player, the smart phone may require functionality to decode and process (e.g., play) the audio/video data. Similarly, if the smart phone includes a camera, the device may require functionality to process and store the resulting image data. Other functionality may be required for gaming, wired or wireless network connectivity, general-purpose computing, and the like. The device may be required to perform many if not all of these tasks simultaneously.

Similarly, a “home gateway” device may provide basic services such as broadband connectivity, Internet connection sharing, and/or firewall security. The home gateway may also perform bridging/routing and protocol and address translation between external broadband networks and internal home networks. The home gateway may also provide functionality for applications such as voice and/or video over IP, audio/video streaming, audio/video recording, online gaming, wired or wireless network connectivity, home automation, VPN connectivity, security surveillance, or the like. In certain cases, home gateway devices may enable consumers to remotely access their home networks and control various devices over the Internet.

Depending on the device, many of the tasks it performs may be processing-intensive and require some specialized hardware or software. In some cases, devices may utilize a host of different components to provide some or all of these functions. For example, a device may utilize certain chips or components to perform modulation and demodulation, while utilizing other chips or components to perform video encoding and processing. Other chips or components may be required to process images generated by a camera. This may require wiring together and integrating a significant amount of hardware and software.

Currently, there is no unified architecture or platform that can efficiently perform many or all of these functions, or at least be programmed to perform many or all of these functions. Thus, what is needed is a unified platform or architecture that can efficiently perform tasks such as data modulation, demodulation, encryption, decryption, encoding, decoding, transcoding, processing, analysis, or the like, for applications such as video, audio, telecommunications, and the like. Further needed is a unified platform or architecture that can be easily programmed to perform any or all of these tasks, possibly simultaneously. Such a platform or architecture would be highly useful in home gateways or other integrated devices, such as mobile phones, PDAs, video/audio players, gaming devices, or the like.

### BRIEF DESCRIPTION OF THE DRAWINGS

In order that the advantages of the invention will be readily understood, a more particular description of the invention briefly described above will be rendered by reference to specific examples illustrated in the appended drawings. Understanding that these drawings depict only typical examples of the invention and are not therefore to be considered limiting of its scope, the invention will be described and explained with additional specificity and detail through use of the accompanying drawings, in which:

FIG. 1 is a high-level block diagram of one embodiment of a data processing architecture in accordance with the invention;

FIG. 2 is a high-level block diagram showing one embodiment of a group in the data processing architecture;

FIG. 3 is a high-level block diagram showing one embodiment of a cluster containing an array of processing elements (i.e., a VPU array);

FIG. 4 is a high-level block diagram showing one example of buffers and connections between buffers;

FIG. 5 is a high-level block diagram showing connection managers for managing data transfer between memory devices, and more particularly between buffers within memory devices;

FIG. 6A is a high-level block diagram showing a pull mechanism for transferring data between buffers;

FIG. 6B is a high-level block diagram showing a push mechanism for transferring data between buffers;

FIG. 7 is a high-level block diagram showing an example of dataflow between buffers in two different clusters;

FIG. 8 is a high-level block diagram showing additional details of a connection manager;

FIG. 9 is a block diagram showing Petri-net notation used in the disclosure;

FIG. 10 is a block diagram showing an example of a pull mechanism from the point-of-view of a single buffer;

FIG. 11 is a block diagram showing an example of a push mechanism from the point-of-view of a single buffer;

FIG. 12 is a block diagram showing an example of both a push and pull mechanism from the point-of-view of a single buffer, in this example a “broadcast” buffer;

FIG. 13 is a high-level block diagram showing one embodiment of an address generation unit within a cluster;

FIG. 14 is a high-level block diagram showing additional details of an address generation unit in accordance with the invention;

FIG. 15A is a block diagram showing one embodiment of a “point-to-point” buffer;

FIG. 15B is a block diagram showing one embodiment of a “broadcast” buffer;

FIG. 15C is a block diagram showing one embodiment of a “scatter” buffer;

FIG. 15D is a block diagram showing one embodiment of a “gather” buffer; and

FIG. 16 is a block diagram showing how vectors may be stored within a buffer.

### DETAILED DESCRIPTION

The present invention provides an apparatus and method for transferring data between memory devices within a data processing architecture that overcomes various shortcomings of the prior art. The features and advantages of the present invention will become more fully apparent from the following description and appended claims, or may be learned by the practice of the invention as set forth hereinafter.

In a first embodiment, an apparatus for transferring data between buffers within a data processing architecture includes first and second memory devices. The apparatus further includes a first connection manager associated with a first buffer in the first memory device, and a second connection manager associated with a second buffer in the second memory device. The first and second connection managers manage data transfers between the first and second buffers. The first connection manager is configured to receive a token from the second connection manager in order to trigger data transfer between the first buffer and the second buffer. The first connection manager is further configured to initiate a data transfer between the first and second buffers in response to receiving the token. This token-based method for initiating data transfers between the connection managers requires little or no CPU intervention.

In selected embodiments, the first connection manager is configured to pull data from the second connection manager if the token indicates that data is available in the second buffer. In other embodiments, the first connection manager is configured to push data to the second connection manager if the token indicates that space is available in the second buffer.

In selected embodiments, the apparatus further includes a first address generation unit associated with the first connection manager and a second address generation unit associated with the second connection manager. The first and second address generation units calculate effective addresses in the first and second buffers, respectively. This configuration enables the first and second connection managers to transfer data between the first and second buffers without knowledge of the effective addresses where the data is stored.

In another embodiment of the invention, an apparatus for transferring data between memory devices within a data processing architecture includes first and second memory devices. The apparatus further includes a first connection manager associated with a first buffer in the first memory device, and a second connection manager associated with a second buffer in the second memory device. The first and second connection managers manage data transfers between the first and second buffers. The apparatus further includes a first address generation unit associated with the first connection manager to calculate effective addresses in the first memory device, and a second address generation unit associated with the second connection manager to calculate effective addresses in the second memory device.

Corresponding methods are also disclosed and claimed herein.

It will be readily understood that the components of the present invention, as generally described and illustrated in the Figures herein, may be arranged and designed in a wide variety of different configurations. Thus, the following more detailed description of the embodiments of the apparatus and methods of the present invention, as represented in the Figures, is not intended to limit the scope of the invention, as claimed, but is merely representative of selected embodiments of the invention.

Many of the functional units described in this specification are shown as modules (or functional blocks) in order to emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose of the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. In the following description, specific details may be provided, such as examples of programming, software modules, user selections, or the like, to provide a thorough understanding of embodiments of the invention. One skilled in the relevant art will recognize, however, that the invention can be practiced without one or more of the specific details, or with other methods or components. In other instances, well-known structures, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

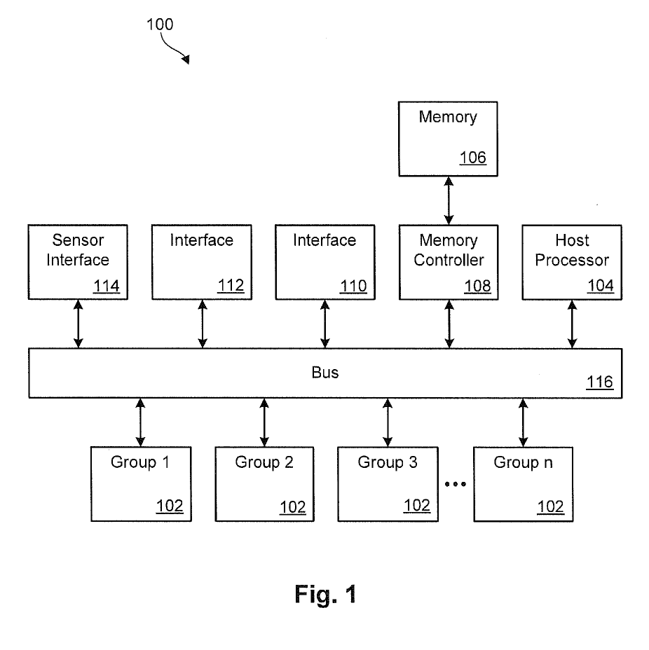

Referring to FIG. 1, one embodiment of a data processing architecture 100 in accordance with the invention is illustrated. The data processing architecture 100 may be used to process (i.e., encode, decode, transcode, analyze, process) audio or video data although it is not limited to processing audio or video data. The flexibility and configurability of the data processing architecture 100 may also allow it to be used for tasks such as data modulation, demodulation, encryption, decryption, or the like, to name just a few. In certain embodiments, the data processing architecture may perform several of the above-stated tasks simultaneously as part of a data processing pipeline.

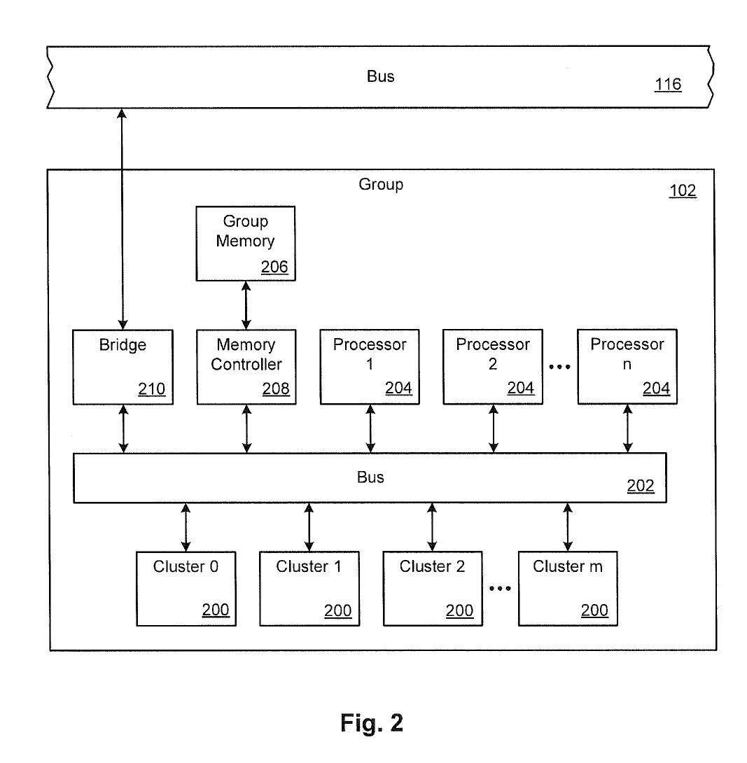

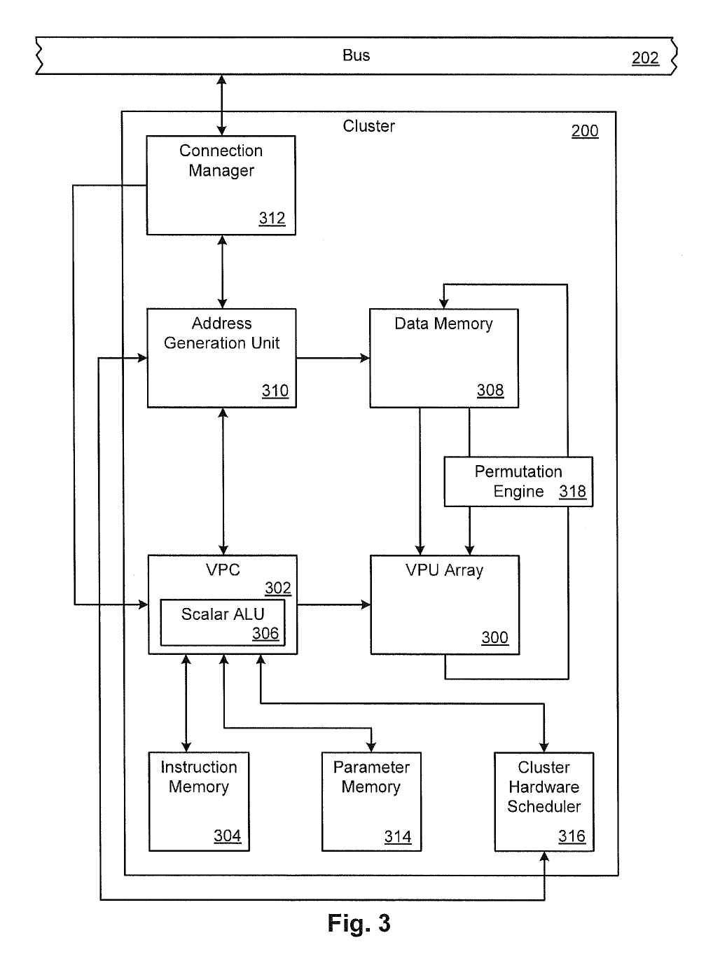

In certain embodiments, the data processing architecture 100 may include one or more groups 102, each containing one or more clusters of processing elements (as will be explained in association with FIGS. 2 and 3). By varying the number of groups 102 and/or the number of clusters within each group 102, the processing power of the data processing architecture 100 may be scaled up or down for different applications. For example, the processing power of the data processing architecture 100 may be considerably different for a home gateway device than it is for a mobile phone and may be scaled up or down accordingly.

The data processing architecture 100 may also be configured to perform certain tasks (e.g., demodulation, decryption, decoding) simultaneously. For example, certain groups and/or clusters within each group may be configured for demodulation while others may be configured for decryption or decoding. In other cases, different clusters may be configured to perform different steps of the same task, such as performing different steps in a pipeline for encoding or decoding video data. For example, where the data processing architecture 100 is used for video processing, one cluster may be used to perform motion compensation, while another cluster is used for deblocking, and so forth. How the process is partitioned across the clusters is a design choice that may differ for different applications. In any case, the data processing architecture 100 may provide a unified platform for performing various tasks or processes without the need for supporting hardware.

In certain embodiments, the data processing architecture 100 may include one or more processors 104, memory 106, memory controllers 108, interfaces 110, 112 (such as PCI interfaces 110 and/or USB interfaces 112), and sensor interfaces 114. A bus 116 or fabric 116, such as a crossbar switch 116, may be used to connect the components together. A crossbar switch 116 may be useful in that it provides a scalable interconnect that can mitigate possible throughput and contention issues.

In operation, data, such as video data, may be streamed through the interfaces 110, 112 into a data buffer memory 106. This data may, in turn, be streamed from the data buffer memory 106 to group memories 206 (as shown in FIG. 2) and then to cluster memories 308 (as shown in FIG. 3), each forming part of a memory hierarchy. Once in the cluster memories 308, the data may be operated on by arrays 300 of processing elements (i.e., VPU arrays 300). The groups and clusters will be described in more detail in FIGS. 2 and 3. In certain embodiments, a data pipeline may be created by streaming data from one cluster to another, with each cluster performing a different function (e.g., motion compensation, deblocking, etc.). After the data processing is complete, the data may be streamed back out of the cluster memories 308 to the group memories 206, and then from the group memories 206 to the data buffer memory 106 and out through the one or more interfaces 110, 112.

In selected embodiments, a host processor 104 (e.g., a MIPS processor 104) may control and manage the actions of each of the components 102, 108, 110, 112, 114 and act as a supervisor for the data processing architecture 100. The host processor 104 may also program each of the components 102, 108, 110, 112 with a particular application (video processing, audio processing, telecommunications processing, modem processing, etc.) before data processing begins.

In selected embodiments, a sensor interface 114 may interface with various sensors (e.g., IRDA sensors) which may receive commands from various control devices (e.g., remote controls). The host processor 104 may receive the commands from the sensor interface 114 and take appropriate action. For example, if the data processing architecture 100 is configured to decode television channels and the host processor 104 receives a command to begin decoding a particular television channel, the processor 104 may determine what the current loads of each of the groups 102 are and determine where to start a new process. For example, the host processor 104 may decide to distribute this new process over multiple groups 102, keep the process within a single group 102, or distribute it across all of the groups 102. In this way, the host processor 104 may perform load-balancing between the groups 102 and determine where particular processes are to be performed within the data processing architecture 100.

Referring to FIG. 2, one embodiment of a group 102 is illustrated. In general, a group 102 may be a semi-autonomous data processing unit that may include one or more clusters 200 of processing elements. The components of the group 102 may communicate over a bus 202 or fabric 202, such as a crossbar switch 202. The internal components of the clusters 102 will be explained in more detail in association with FIG. 3. In certain embodiments, a group 102 may include one or more management processors 204 (e.g., MIPS processors 204), group memories 206 and associated memory controllers 208. A bridge 210 may connect the group 102 to the primary bus 116 or fabric 116 illustrated in FIG. 1. Among other duties, the management processors 204 may perform load balancing across the clusters 200 and dispatch tasks to individual clusters 200 based on their availability. Prior to dispatching a task, the management processors 204 may, if needed, send parameters to the clusters 200 in order to program them to perform particular tasks. For example, the management processors 204 may send parameters to program an address generation unit, a cluster scheduler, or other components within the clusters 200, as shown in FIG. 3.

Referring to FIG. 3, in selected embodiments, a cluster 200 in accordance with the invention may include an array 300 of processing elements (i.e., a vector processing unit (VPU) array 300). An instruction memory 304 may store instructions associated with threads running on the cluster 200 and intended for execution on the VPU array 300. A vector processor unit controller (VPC) 302 may fetch instructions from the instruction memory 304, decode the instructions, and transmit the decoded instructions to the VPU array 300 in a “modified SIMD” fashion. The VPC 302 may act in a “modified SIMD” fashion by grouping particular processing elements and applying an instruction modified to each group. This may allow different processing elements to handle the same instruction differently. For example, this mechanism may be used to cause half of the processing elements to perform an ADD instruction while the other half performs a SUB instruction, all in response to a single instruction from the instruction memory 304. This feature adds a significant amount of flexibility and functionality to the cluster 200.

The VPC 302 may have associated therewith a scalar ALU 306 which may perform scalar computations, perform control-related functions, and manage the operation of the VPU array 300. For example, the scalar ALU 306 may reconfigure the processing elements by modifying the groups that the processing elements belong to or designating how the processing elements should handle instructions based on the group they belong to.

The cluster 200 may also include a data memory 308 storing vectors having a defined number (e.g., sixteen) of elements. In certain embodiments, the number of elements in each vector may be equal to the number of processing elements in the VPU array 300, allowing each processing element within the array 300 to operate on a different vector element in parallel. Similarly, in selected embodiments, each vector element may include a defined number (e.g., sixteen) of bits. For example, where each vector includes sixteen elements and each element includes sixteen bits, each vector would include 256 bits. The number of bits in each element may be equal to the width (e.g., sixteen bits) of the data path between the data memory 308 and each processing element. It follows that if the data path between the data memory 308 and each processing element is 16-bits wide, the data ports (i.e., the read and write ports) to the data memory 308 may be 256-bits wide (16 bits for each of the 16 processing elements). These numbers are presented only by way of example are not intended to be limiting.

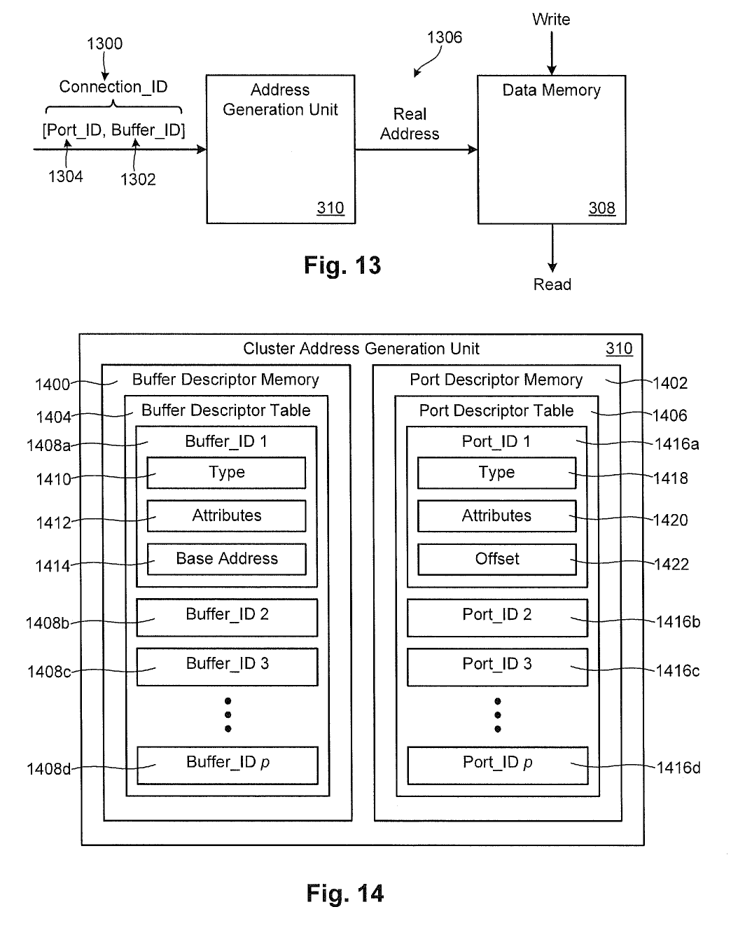

In selected embodiments, the cluster 200 may include an address generation unit 310 to generate real addresses when reading data from the data memory 308 or writing data back to the data memory 308. As will be explained in association with FIGS. 13 and 14, in selected embodiments, the address generation unit 310 may generate addresses in response to read/write requests from either the VPC 302 or connection manager 312 in a way that is transparent to the VPC 302 and connection manager 312. The cluster 200 may include a connection manager 312, communicating with the bus 202 or fabric 202, whose primary responsibility is to transfer data into and out of the cluster data memory 308 to/from the bus 202 or fabric 202.

In selected embodiments, instructions fetched from the instruction memory 304 may include a multiple-slot instruction (e.g., a three-slot instruction). For example, where a three-slot instruction is used, up to two (i.e., 0, 1, or 2) instructions may be sent to each processing element and up to one (i.e., 0 or 1) instruction may be sent to the scalar ALU 306. Instructions sent to the scalar ALU 306 may, for example, be used to change the grouping of processing elements, change how each group of processing elements should handle a particular instruction, or change the configuration of a permutation engine 318. In certain embodiments, the processing elements within the VPU array 300 may be considered parallel-semantic, variable-length VLIW (very long instruction word) processors, where the packet length is at least two instructions. Thus, in certain embodiments, the processing elements in the VPU array 300 may execute at least two instructions in parallel in a single clock cycle.

In certain embodiments, the cluster 200 may further include a parameter memory 314 to store parameters of various types. For example, the parameter memory 314 may store a processing element (PE) map to designate which group each processing element belongs to. The parameters may also include an instruction modifier designating how each group of processing elements should handle a particular instruction. In selected embodiments, the instruction modifier may designate how to modify at least one operand of the instruction, such as a source operand, destination operand, or the like.

In selected embodiments, the cluster 200 may be configured to execute multiple threads simultaneously in an interleaved fashion. In certain embodiments, the cluster 200 may have a certain number (e.g., two) of active threads and a certain number (e.g., two) of dormant threads resident on the cluster 200 at any given time. Once an active thread has finished executing, a cluster scheduler 316 may determine the next thread to execute. In selected embodiments, the cluster scheduler 316 may use a Petri net or other tree structure to determine the next thread to execute, and to ensure that any necessary conditions are satisfied prior to executing a new thread. In certain embodiments, the group processor 204 (shown in FIG. 2) or host processor 104 may program the cluster scheduler 316 with the appropriate Petri nets/tree structures prior to executing a program on the cluster 200.

Because a cluster 200 may execute and finish threads very rapidly, it is important that threads can be scheduled in an efficient manner. In certain embodiments, an interrupt may be generated each time a thread has finished executing so that a new thread may be initiated and executed. Where threads are relatively short, the interrupt rate may become so high that thread scheduling has the potential to undesirably reduce the processing efficiency of the cluster 200. Thus, apparatus and methods are needed to improve scheduling efficiency and ensure that scheduling does not create bottlenecks in the system. To address this concern, in selected embodiments, the cluster scheduler 316 may be implemented in hardware as opposed to software. This may significantly increase the speed of the cluster scheduler 316 and ensure that new threads are dispatched in an expeditious manner. Nevertheless, in certain cases, the cluster hardware scheduler 316 may be bypassed and scheduling may be managed by other components (e.g., the group processor 204).

In certain embodiments, the cluster 200 may include permutation engine 318 to realign data that it read from or written to the data memory 308. The permutation engine 318 may be programmable to allow data to a reshuffled in a desired order before or after it is processed by the VPU array 300. In certain embodiments, the programming for the permutation engine 318 may be stored in the parameter memory 314. The permutation engine 318 may permute data having a width (e.g., 256 bits) corresponding to the width of the data path between the data memory 308 and the VPU array 300. In certain embodiments, the permutation engine 318 may be configured to permute data with a desired level of granularity. For example, the permutation engine 318 may reshuffle data on a byte-by-byte or element-by-element basis or other desired level of granularity. Using this technique, the elements within a vector may be reshuffled as they are transmitted to or from the VPU array 300.

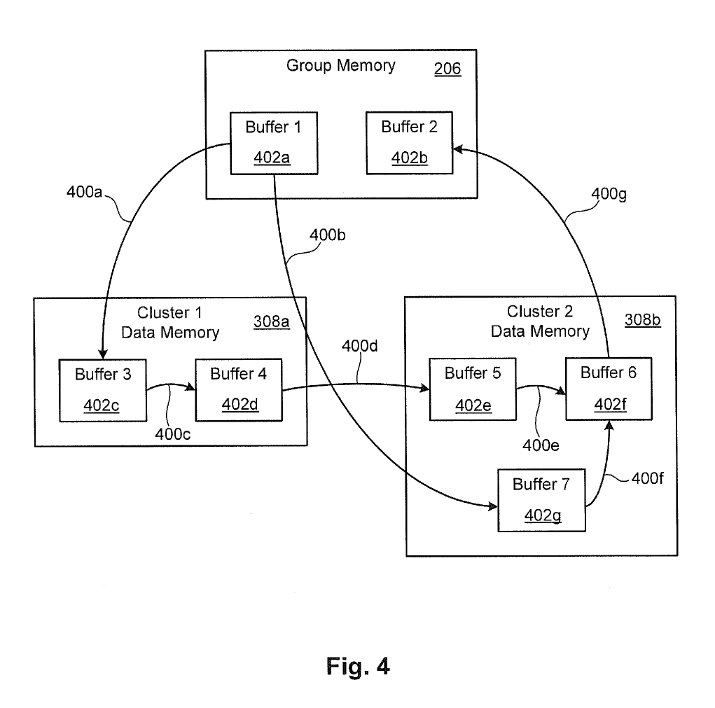

Referring to FIG. 4, while continuing to refer generally to FIG. 3, as previously mentioned in association with FIG. 1, as data is processed by the data processing architecture 100, data may be streamed between different memory devices in the architecture 100. For example, when video data is processed, data may be initially streamed into the data buffer memory 106, and then into the group memories 206 and cluster memories 308 where it may be processed by the cluster VPU arrays 300. In certain applications, data may be streamed between the data memories 308 of different clusters 200, with each cluster 200 performing some operation on the data. Processed video data may then be streamed out of the data processing architecture 100 in the opposite direction. The way data is streamed through the data processing architecture 100 may ultimately depend on the application and the operations that are performed on the data.

In selected embodiments, “connections” may be established between particular memory devices, and more particularly between buffers in the memory devices, to establish how data flows through the data processing architecture 100. The data processing architecture 100 may be programmed with these “connections” prior to running an application and prior to streaming data through the architecture 100. For example, FIG. 4 shows a group memory 206 and data memories 308a, 308b for two different clusters 200 in the data processing architecture 100. Buffers 402a-g may be established in the memories 206, 308a, 308b to temporarily store data as it streams therethrough.

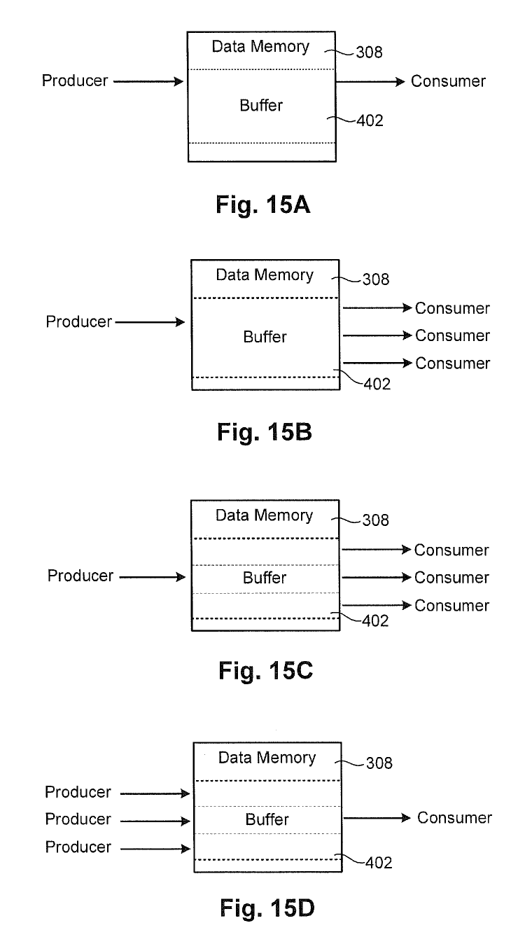

A series of “connections” 400 may be established between the buffers 402a-g to define how data flows therebetween. For example, as shown in FIG. 4, the buffer 402a may stream data to the buffer 402c by way of a connection 400a, the buffer 402c may stream data to the buffer 402d by way of a connection 400c, the buffer 402d may stream data to the buffer 402e by way of a connection 400d, and so forth. In selected embodiments, the buffers 402a-g may be configured to stream data to multiple locations, or receive data from multiple locations. For example, the buffer 402a may stream data (either the same or different data) to multiple buffers 402c, 402g, while the buffer 402f may receive data (either the same or different data) from multiple buffers 402e, 402g. This concept is described in more detail in association with the “broadcast,” “gather,” and “scatter” buffers described in FIGS. 15B through 15D.

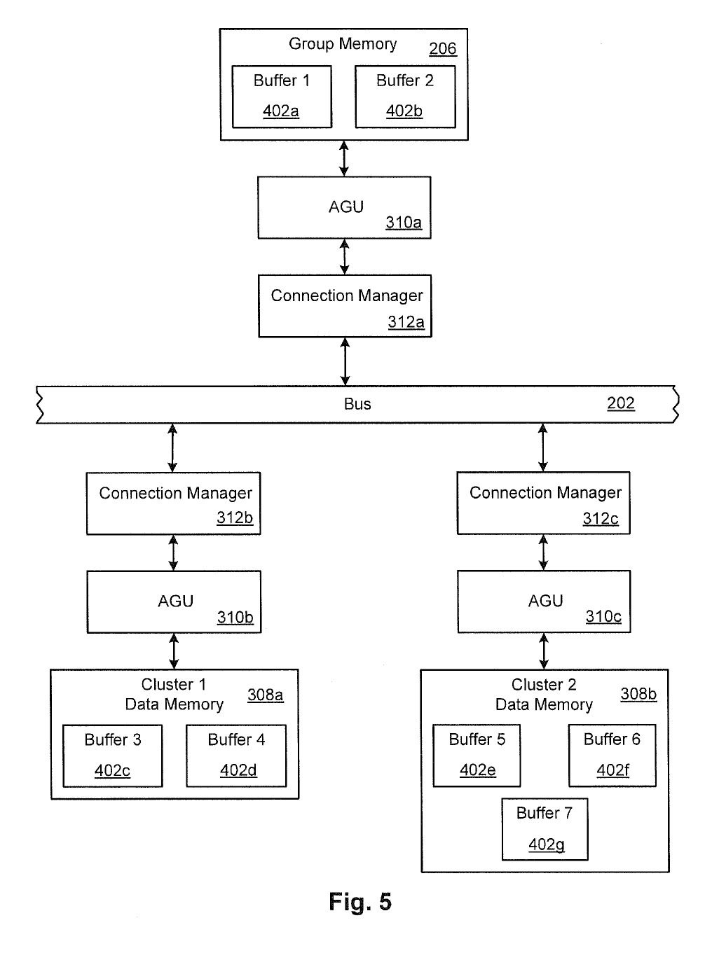

As shown in FIG. 5, each memory device 206, 308a, 308b described in FIG. 4 may be associated with a connection manager 312a-c, which may control the flow of data into and out of the memory device 206, 308a, 308b, and more particularly into and out of the buffers 402a-g of the memory device 206, 308a, 308b. The connection managers 312a-c may communicate with and exchange data over a bus 202 or fabric 202. For illustrative purposes, each of the memory devices 206, 308a, 308b and buffers 402a-g shown in FIG. 4 are shown in FIG. 5, although fewer or additional memory devices, buffers, and connection managers may be present. As will be explained in more detail hereafter, each connection manager 312 may manage “connections” and store information associated with the “connections” 400 that it manages.

As further shown in FIG. 5, an AGU 310a-c may be associated with each connection manager 312a-c. The AGUs 310a-c may calculate effective addresses for data transferred into and out of their respective memory devices 206, 308a, 308b. The connection managers 312a-c, although mediating and controlling exchanges of data between the memory devices 206, 308a, 308b, may not have knowledge of the real addresses where data is stored or retrieved from the memory devices 206, 308a, 308b. As will be described in association with FIG. 14, instead of designating a real address in memory, a connection manager 312 may provide a connection_ID to the AGU 310. The AGU 310 may, in turn, translate this connection_ID into a real address in memory so that data can be stored or retrieved therefrom.

As shown in FIG. 5, a connection manager 312 and AGU 310 may be associated with each group memory 206 and each cluster data memory 308. More specifically, the cluster connection managers 312b, 312c and AGUs 310b, 310c may manage buffers in the cluster data memories 308a, 308b, while the group connection manager 312a and AGU 310a may manage buffers in the group memory 206. In selected embodiments, the group connection manager 312a and AGU 310a may also manage buffers in the main memory 106 (as shown in FIG. 1) or data transfers to other memory or IO devices communicating with the buses 116, 202 or fabrics 116, 202. The configuration shown in FIG. 5 is simply one embodiment of how the connection managers 312 may be configured. In other embodiments, the connection managers 312 may be configured to manage buffers in local and/or remote memories 206, 308. For example, a connection manager 312 may manage connections to other connection managers 312 through a fabric, and an AGU 310 may generate effective addresses to another fabric or the same fabric the connection manager 312 is communicating with rather than a local memory as shown.

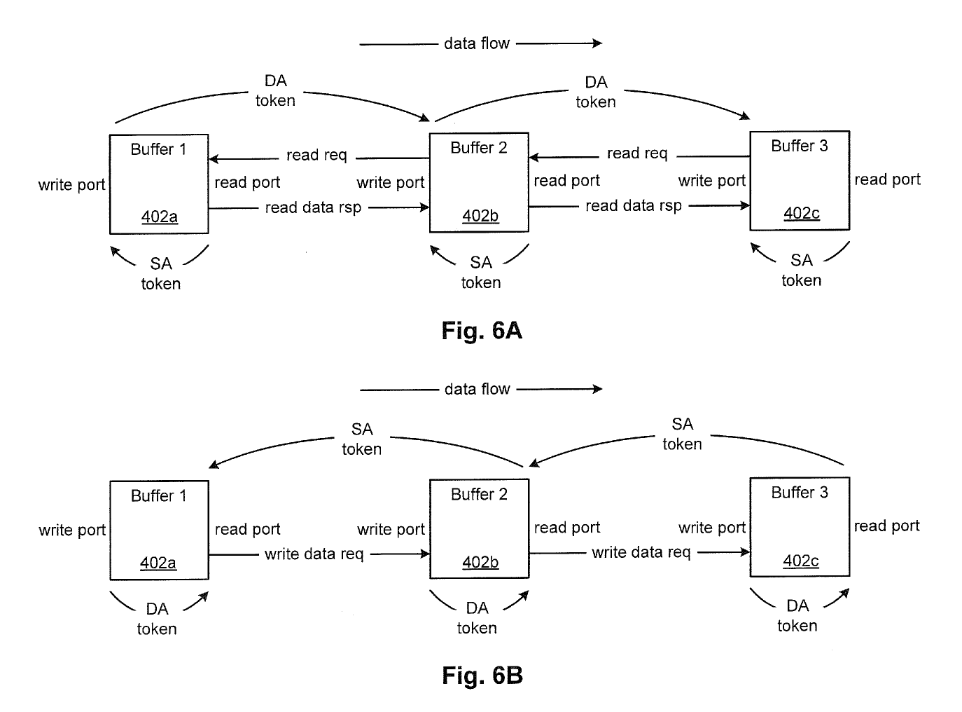

Referring to FIGS. 6A and 6B, the connection managers 312 described in FIG. 5 may use two primary methods for transferring data between buffers 402, namely pushing and pulling data. Using either method, the connection managers 312 may exchange “tokens,” which may, in certain embodiments, indicate that either data or space is available. The connection managers 312 may then initiate data transfers when all necessary tokens have been received. In general, the tokens may have other meanings than just indicating that data or space is available. More generally, tokens can represent anything as part of a general data flow diagram represented by a Petri-net.

FIG. 6A shows one example of a method for transferring data between buffers 402 using a pull mechanism. FIG. 6B shows an example of a method for transferring data between buffers 402 using a push mechanism. The connection managers 312, and more particularly each connection, may be configured to use either a push or a pull mechanism when transferring data.

As shown in FIGS. 6A and 6B, each buffer 402 may have at least one write port, where data is written into the buffer 402, and at least one read port, where data is read from the buffer 402. A “connection,” which is essentially a channel between two buffers 402, may be associated with a read port of one buffer 402 and a write port of another buffer 402. When certain events occur, tokens may be generated by a read or write port of one buffer 402 and sent to a read or write port of another buffer 402.

For example, FIG. 6A shows a series of connections between buffers 402a-c that are configured to transfer data using a pull mechanism. Using a pull mechanism, the write port of each buffer 402a-c acts as the active side of the connection (i.e., the side that initiates the data transfer) and the read port of each buffer 402a-c acts as the passive side of the connection. When data has been written to a buffer 402a, the write port of the buffer 402a may be configured to generate a data available (DA) token. This DA token may be received by the write port of a buffer 402b to indicate that data is available in the buffer 402a. Similarly, when data is read from the buffer 402b (through its read port), the buffer's read port may generate a space available (SA) token indicating that space is available in the buffer 402b. This SA token may be sent to the write port of the buffer 402b. When the write port of the buffer 402b has received both the DA token and the SA token, it will know that both data is available in buffer 402a and that space is available in buffer 402b. The write port of the buffer 402b may then initiate a data transfer from buffer 402a to buffer 402b. It may do this by sending a read request (“read req”) signal to the read port of buffer 402a and waiting for a response (“read data rsp”) indicating that it can read data.

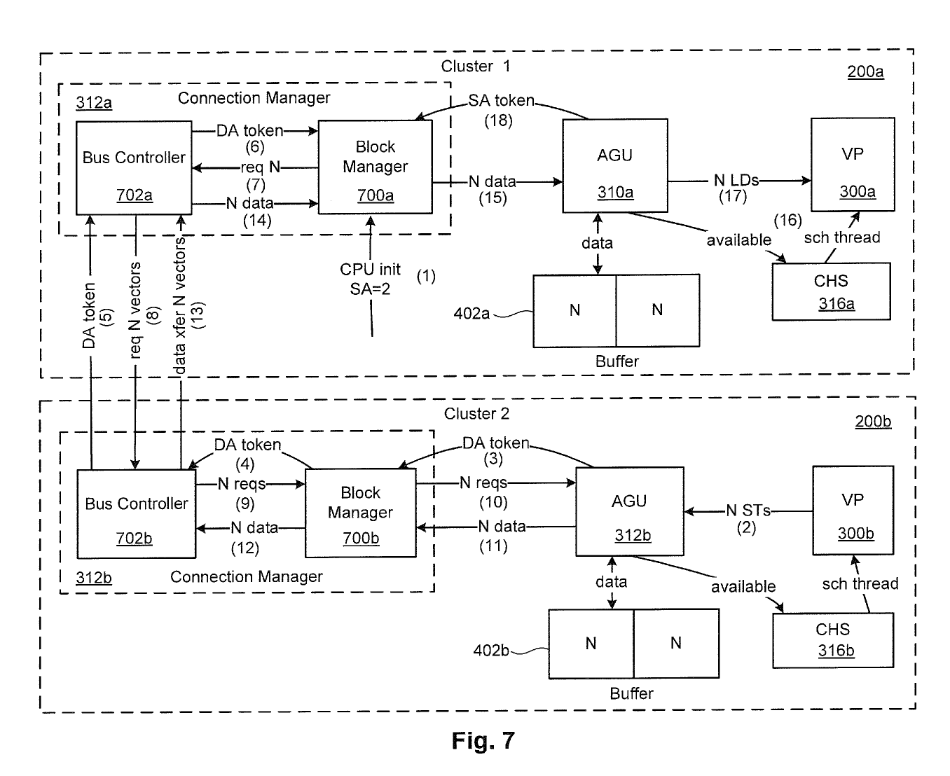

Once this response is received, the write port of the buffer 402b may read the data from the buffer 402a (thereby “pulling” data from the buffer 402a to the buffer 402b). When data it written to the buffer 402b, the buffer 402b may send a DA token to buffer 402c. When space is available in buffer 402c, the buffer 402c may initiate a data transfer in the same manner previously described. In this manner, by using tokens to indicate data and space availability, data may be transferred from one buffer 402 to another. Although not shown, the connection managers 312 and AGUs 310 associated with each of the buffers 402a, 402b, 402c may control the data transfer between the buffers 402. More particularly, the connection managers 312 and AGUs 310 may generate and receive the tokens, as well as initiate data transfers between the buffers 402, as will be shown in more detail in association with FIG. 7.

FIG. 6B shows a series of connections between buffers 402a-c that are configured to transfer data using a push mechanism. Using a push mechanism, the read port (also referred to as the producer port) of each buffer 402a-c acts as the active side of the connection (i.e., the side that initiates the data transfer) and the write port of each buffer 402a-c acts as the passive side of the connection. When data has been written to a buffer 402a, the write port of the buffer 402a may generate a data available (DA) token, which may be sent to the read port of the buffer 402a. Similarly, when data is read from the buffer 402b (through its read port), the buffer's read port 402b may generate a space available (SA) token indicating that space is available in the buffer 402b. This SA token may also be sent to the read port of the buffer 402a. When the read port has received both the DA token and the SA token, it will know that both data is available in buffer 402a and that space is available in buffer 402b. The read port of the buffer 402a may then initiate a data transfer from buffer 402a to buffer 402b. It may do this by sending a write data request (“write data req”) signal and then transmitting data to the buffer 402b (thereby “pushing” data to the buffer 402b).

When data has been written to the buffer 402b, the write port of the buffer 402b may send a DA token to the read port of the buffer 402b, indicating that data is available in the buffer 402b. When space is available in the buffer 402c (as indicated by an SA token transmitted to the read port of the buffer 402b), the read port of the buffer 402b may initiate a data transfer in the same manner previously described. As previously mentioned, the connection managers 312 and AGUs 310 associated with each buffer 402a-c may generate and receive the tokens, as well as initiate data transfers between the buffers 402a-c.

Referring to FIG. 7, a high-level block diagram illustrating the transfer of a block of N vectors from one cluster 200b to another cluster 200a is shown. As shown, each connection manager 312a, 312b may include two sub-components: (1) a block manager 700 and (2) a bus controller 702. The block manager 700 may be responsible for managing blocks of data and making requests to its associated AGU 310 and bus controller 702. The bus controller 702 may receive commands from the block manager 700 to send/fetch data to/from remote connections or send/receive tokens to/from remote connections, and convert those into appropriate bus transactions.

The illustrated example uses a double buffer scheme where a buffer of size 2N is divided into two blocks of N vectors each. Each SA (space available) or DA (data available) token represents a block of N vectors. Starting from reset, a data transfer may be initiated by the following the steps (as indicated by numerals 1 through 18 in FIG. 7):
1) An external CPU may initially send two SA tokens to the block manager 700a of cluster 1.
2) At some point in time, the VPU array 300b of cluster 2 completes N store instructions, thereby filling the buffer 402b with a block of N vectors.
3) The AGU 312b of cluster 2 recognizes that a full block of N vectors is available in the buffer 402b and sends a DA token to the block manager 700b.
4) The block manager 700b sends a DA token to the bus controller 702b.
5) The bus controller 702b sends a DA token to the bus controller 702a of cluster 1 over the bus 202 (not shown).
6) The bus controller 702a sends a DA token to the block manager 700a.
7) The block manager 700a now has both of the required tokens (i.e., the SA and DA tokens) required to receive a block of vectors. It requests N vectors from the bus controller 702a.
8) The bus controller 702a requests N vectors over the bus 202.
9) The bus controller 702b receives the request and sends a request of N vectors to the block manager 700b.
10) The block manager 700b receives the request and requests N vectors from the AGU 312b.
11) The AGU 312b responds with N vectors of data.
12) The block manager 700b forwards the N vectors of data to the bus controller 702b.
13) The bus controller 702b transmits the N vectors of data over the bus 202.
14) The bus controller 702a receives the N vectors of data and forwards them to the block manager 700a.
15) The block manager 700a forwards the data to the AGU 310a.
16) When the AGU 310a receives enough data, it generates a data available signal to the cluster hardware scheduler (CHS) 316a which then schedules a thread.
17) The scheduled thread then consumes the N vectors by way of N load instructions executed on the VPU array 300a.
18) When the N vectors are consumed by the VPU array 300a, the AGU 310a sends an SA token to the block manager 700a and the process loops back to step 2.

The process described above provides one possible scenario for transferring data and is not intended to be limiting. It is important to note that step 2, which fills the buffer with the next block of vectors, can be performed in parallel with steps 3 through 18. This is possible because the buffer 402a in cluster 2 may also be double-buffered. Thus, while the first block of vectors is being transferred to cluster 1, cluster 2 can produce a second block of vectors, thus making the production of data, consumption of data, and transfer of data asynchronous processes.

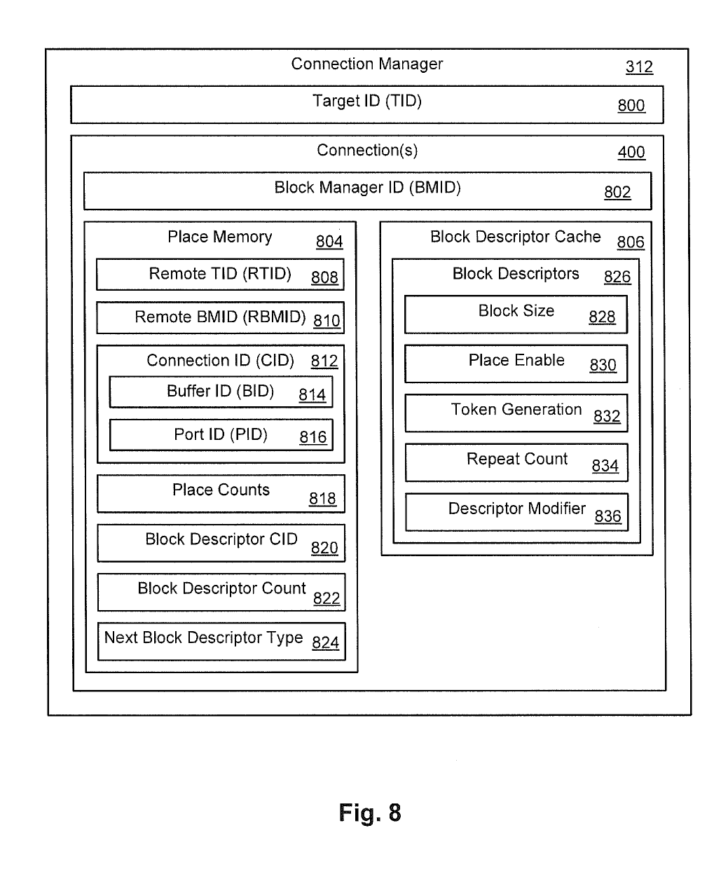

FIG. 8 shows various details of one embodiment of a connection manager 312 that allow it to operate in the described manner. As shown, in selected embodiments, each connection manager 312 may be assigned a target ID (TID) 800 allowing it to communicate with other connection managers 312 and/or devices. In certain embodiments, the TID 800 is permanent and non-configurable. In certain embodiments, other devices, such as the host CPU 104, may also be assigned a TID, allowing these devices to directly communicate with, or read or write data to, the connection managers 312. When data or other communications are sent out onto the bus 202, the TID 800 of the destination connection manager 312 or device may be attached to the data or communications. This may allow the connection manager 312 or device to identify data or communications that are intended for it and ignore data and communications intended for other destinations.

As previously mentioned, multiple data streams or channels may be established between each of the connection managers 312. Each of these data streams or channels may be referred to as “connections” 400, as previously discussed. These connections 400 may be configured to use either a push or pull mechanism to transfer data, depending on which connection manager 312 is configured to act as the active and passive side of the connection 400. In selected embodiments, a connection manager 312 may store a block manager ID (BMID) 802 for each connection 400 coming in or out of the connection manager 312. In certain embodiments, each connection manager 312 may be configured to support a certain number of connections coming in or out of the connection manager 312, and thus may store a limited number of BMIDs. In selected embodiments, the BMID 802 may provide an index into a place memory 804 and a block descriptor cache 806 stored in an internal memory of the connection manager 312. The place memory 804 may store data that does not change often, whereas the block descriptor cache 806 may store data that is frequently subject to change. The place memory 804 and block descriptor cache 806 may store configuration data for each connection coming in or out of the connection manager 312.

In selected embodiments, each BMID 802 may have associated therewith a remote TID (RTID) 808 and a remote BMID (RBMID) 810. This RTID 808 and RBMID 810 may identify the TID and BMID for the connection manager 312 located at the other end of the connection. The connection managers 312 located at each end of the connection may have different BMIDs 802 associated with the same connection. The BMID 802 may also map to a connection ID 812 associated with the AGU 310 corresponding to the connection manager 312. The connection ID 812 may be composed of both a buffer ID (BID) 814 and port ID (PID) 816. The BID 814 and PID 816 correspond to a buffer and port, respectively. The buffer may identify a region in data memory 308 where data is stored. The port may identify an access pattern for reading or writing data to the buffer. This concept will be explained in more detail in association with FIGS. 13 through 16.

The place memory 804 may also include a place counts field 818, which provides locations to store DA or SA tokens in order for a data transfer to take place. The place counts field 818 works in conjunction with the place enable mask 830, which will be described in more detail hereafter. A block descriptor CID 820 may identify a buffer (i.e., a BDL buffer) in data memory 308 which stores a block descriptor list (i.e., a BDL). Block descriptors (BDs) and their function will be described in more detail hereafter. Storing block descriptors in memory 308 allows the connection manager 312 to store a relatively small number of block descriptors (e.g., a single block descriptor per BMID) in its internal descriptor cache 806, while allowing it to fetch additional block descriptors from the data memory 308 as needed. This reduces the size of the cache needed to implement the block descriptor cache 806.

A block descriptor count 822 may store the number of block descriptors that are stored in a BDL for a particular BMID. The next block descriptor type 824 may indicate the next block descriptor type to be used after transferring the current block. For example, the next block descriptor type 824 may include (1) auto reload (in which one block descriptor is initialized in the BD cache 806 and reused for all block transfers); (2) sequence_no_count (in which a new block descriptor is fetched from the BDL and stored in the BD cache 806 as soon as it is needed); and (3) sequence_count (in which the connection manager 312 maintains a count of the number of BDs available in the BDL buffer. If the count is 0, no descriptors are fetched from the BDL until software notifies the connection manager 312 that additional BDs are available).

As previously mentioned, the block descriptor cache 806 may store block descriptors 826 for each BMID 802. In selected embodiments, the block descriptor cache 806 may store a single block descriptor 826 for each BMID 802. A block descriptor 826 may include various fields. For example, the block descriptor 826 may include a block size field 828 indicating how many vectors are to be included in a block. Instead of transferring individual vectors, the connection managers 312 may transfer blocks of multiple vectors, the size of which is indicated in the block size field 828. The block size may change (using sequence_no_count or sequence_count block descriptor types, for example) as new block descriptors are fetched from memory 308 and loaded into the block descriptor cache 806.

A block descriptor 826 may also include a place enable field 830, indicating which places (of the place counts field 818) need to contain tokens in order for a data transfer to take place. For example, if there are five places in the place counts field 818, the place enable field 830 may indicate that tokens are needed in the first three places in order to initiate a data transfer. The token generation field 832, on the other hand, may indicate which tokens should be generated and where they should be sent after a data transfer is complete.

A repeat count 834 may store the number of times to re-use a block descriptor entry 826 before loading a new block descriptor 826 from memory 308 (see, for example, sequence_no_count description above). A descriptor modifier 836 may indicate what modifications are needed by the AGU 310 prior to transferring a block of vectors. For example, the descriptor modifier 836 may be used to modify AGU port and buffer descriptors (e.g., by modifying the base address in the buffer descriptor and/or the offset in the port descriptor, etc.). These descriptor modifiers 836 may be sent to the AGU 310 before a new block transfer is initiated. These descriptor modifiers 836 may be applied to the port or buffer descriptor associated with the block descriptor's BMID 802.

The connection manager 312 and AGU 310 together provide a sophisticated mechanism for moving data similar to a traditional DMA, but differ from a traditional DMA in various important aspects. The connection manager 312 provides hardware support for managing buffers within memories 308 by automatically transferring data between buffers, and the AGU 310 allows data to be accessed in different patterns as it is read from or written to different memories 308.

The connection manager 312 and AGU 310 differ from traditional DMAs in both features and architecture in order to minimize CPU intervention. For example, the connection manager 312 and AGU 310 may be optimized to support continuous streaming of data without any CPU interrupts or intervention. All the space and data available signaling and data transfer may be performed by the connection manager 312. Also, unlike traditional DMA, source address generation and destination address generation are controlled by separate descriptors distributed across different connection managers 312. This allows, for example, multiple descriptors of source address generation to map to a single destination descriptor. The source address is calculated by the producer AGU 310, while the destination address is calculated by the consumer AGU 310.

One reason for the distributed address generation is to decouple the source address pattern from the destination address pattern. For example, data could be read from the producer memory 308 as a complex nested loop with wrapping and skipping, while the data is written in the consumer memory 308 in a simple FIFO pattern. Another difference is the address used to transfer data between connection managers 312 is neither the source address nor the destination address, but rather an identifier associated with a particular connection or data stream. Finally, the connection manager 312 supports general Petri-net representations for system dataflow, providing more flexibility than a traditional DMA.

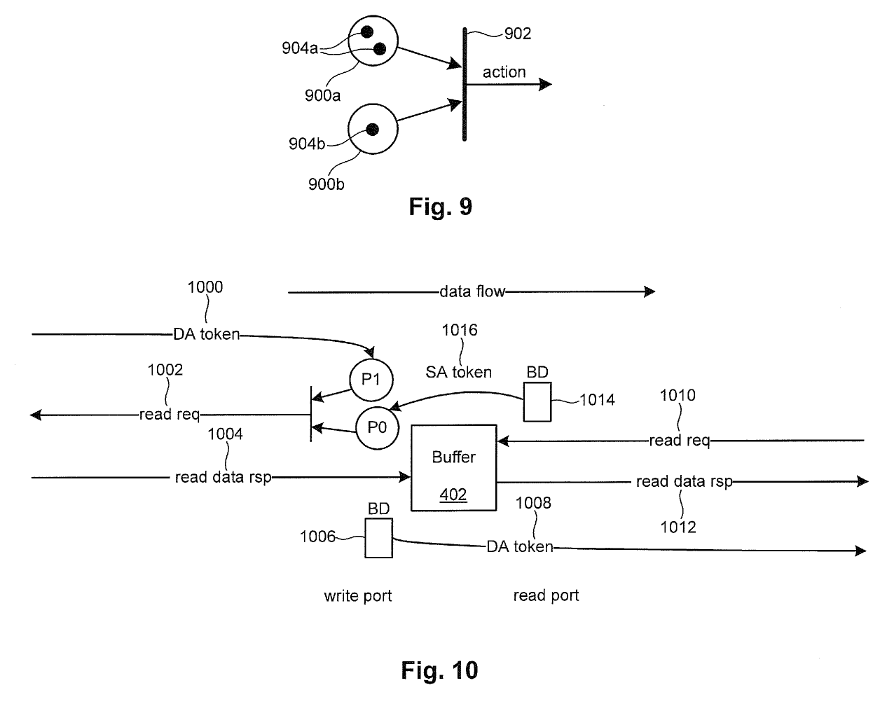

Referring to FIG. 9, a block diagram showing the Petri-net notation used in FIGS. 10 through 12 is illustrated. As shown, a Petri-net may include places 900a, 900b and transitions 902. The places 900a, 900b may receive one or more tokens 904a, 904b. When all necessary tokens 904a, 904b are present in the places 900a, 900b, this may trigger a transition 902, which may cause some action to occur. For example, the token(s) 904a may represent DA tokens 904a and the token 904b may represent an SA token 904b, as previously described. When a certain number of DA tokens 904a and SA tokens 904b have been received, this may trigger the transition 902, which may initiate a data transfer.

Referring to FIG. 10, the pull mechanism from the point-of-view of a single buffer 402 is illustrated using the Petri-net notation discussed above. When data is written into a buffer upstream from the buffer 402, a DA token 1000 may be sent to the write port of the buffer 402 indicating that data is available. This DA token 1000 may be stored in a place P1. The block descriptor 1006 associated with the write port may then be activated since data is available upstream and space is available in the buffer 402 (assuming an SA token is already in place P0). A read request 1002 may then be initiated to the upstream read port and a response 1004 may be received from the upstream read port. When a block of vectors arrives at the write port of the buffer 402, the block descriptor 1006 is complete and a DA token 1008 is sent to the write port of a downstream buffer indicating that data is available. A read request 1010 may then be received from the downstream buffer and a response 1012 may be returned to the downstream buffer. A block of vectors may then be read from the buffer 402 by the downstream buffer and the read port of the buffer 402 (associated with a read port block descriptor 1014) may send an SA token 1016 to the write port indicating that space is available, and the process may repeat.

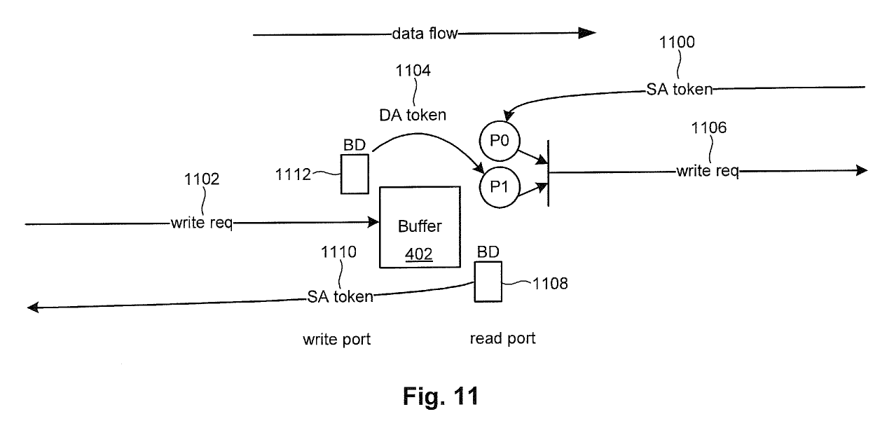

Referring to FIG. 11, the push mechanism from the point-of-view of a single buffer 402 is illustrated. When space is available in a downstream buffer (because data has continued moving downstream), an SA token 1100 may be sent to the read port of the buffer 402. When a write request 1102 and a block of vectors has been received by the buffer 402, the write port (associated with block descriptor 1112) of the buffer 402 may send a DA token 1104 to the read port of the buffer 402. Once both the SA token 1100 and the DA token 1104 have been received (in places P0 and P1), a write request 1106 and a block of vectors may be sent to the downstream write port. Once the block of vectors is transmitted downstream, the read port block descriptor 1108 completes and an SA token 1110 is sent to the read port of the upstream buffer, and the process may begin again.

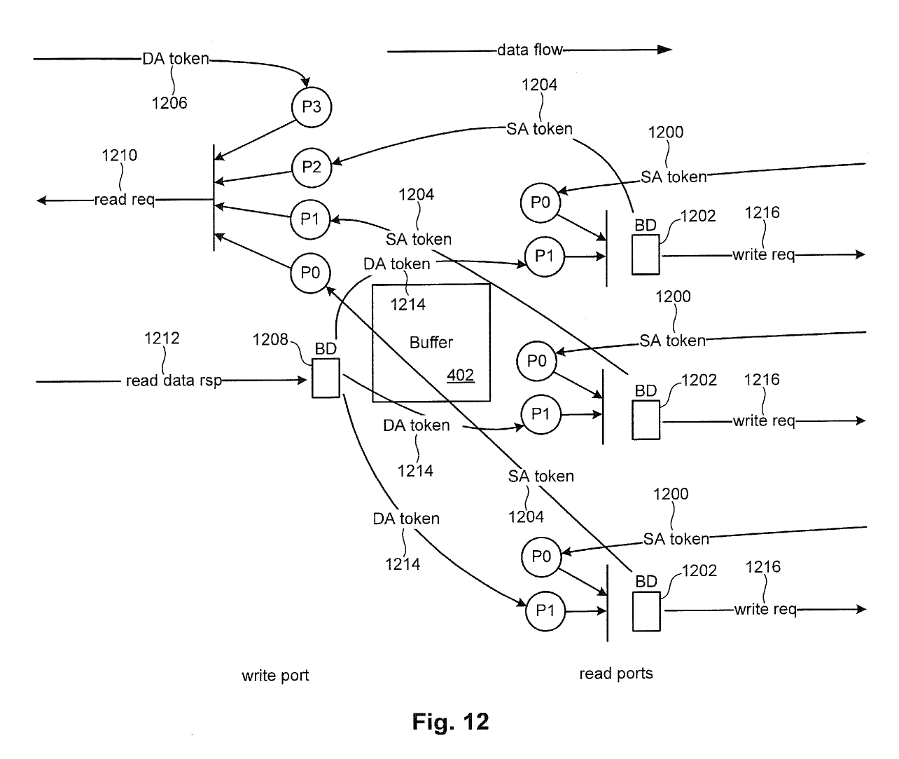

Referring to FIG. 12, both the pull and push mechanisms from the point-of-view of a single buffer 402 are illustrated. In this example, the buffer 402 is a “broadcast” buffer, as will be explained in more detail in association with FIG. 15B. As explained in FIGS. 15B through 15D, “broadcast,” “scatter,” and “gather” buffers may have multiple read and/or write ports. In the illustrated example, data is pulled into the buffer 402 from a single upstream buffer, and then pushed into three downstream buffers.

When space is available in each of the three downstream buffers (because data has continued moving downstream), an SA token 1200 may be sent from each of the downstream buffers (in an asynchronous manner) to each of the read ports of the buffer 402. Upon receiving the SA tokens 1200, the block descriptor 1202 for each read port may send an SA token 1204 to the write port of the buffer 402 (which are stored in places P0, P1, and P2). Similarly, when data is written to an upstream buffer, a DA token 1206 may be sent to the write port of the buffer 402 (and stored in place P3) indicating that data is available. When all required tokens are received by the write port, the block descriptor 1208 associated with the write port may be activated. A read request 1210 may then be sent to the upstream read port. A response 1212 and a block of vectors may then be received from the upstream buffer. When a block of vectors arrives at the buffer 402, the block descriptor 1208 is complete and DA tokens 1214 may be sent to each of the read ports of the buffer 402. Upon receiving the DA tokens 1214, each of the read ports may have all the required tokens (in P0 and P1) to initiate a data transfer. The read ports may then send a write request 1216 and a block of vectors (which may be identical blocks of vectors) to each of the downstream buffers.

The examples provided in FIGS. 10 through 12 are provided by way of example to illustrate push and pull mechanisms that may be implemented by the connection managers 312. These examples are not intended to be limiting. Indeed the connection managers 312 may be configured with different numbers of read and write ports, each of which may be configured to push or pull data in different manners.

Furthermore, it should be recognized that the exchange of tokens between connection managers 312 is only one way to initiate data transfers between connection managers 312. For example, in other embodiments, software may be configured to generate and transmit tokens to connection managers 312 to initiate data transfers therebetween. In other embodiments, the connection managers 312 themselves may be configured to initiate data transfers without receiving or transmitting any tokens. Once the data flow has started, the connection managers 312 may generate and exchange tokens to keep the data flowing.

It should also be recognized that the connection managers 312 may include other functionality in addition to that described herein. For example, a connection manager 312 may be configured to support loopback connections from one buffer 402 to another 402 where both buffers 402 are located in the same physical memory device 206, 308. These loopback connections may be configured as either push or pull connections. In general, tokens may be generated from one buffer 402 to another 402 all within the same memory device 206, 308 and managed by the same connection manager 312.

Referring to FIG. 13, as previously mentioned, in selected embodiments, an address generation unit 310 may be used to generate real addresses in response to read/write requests from either the VPC 302 or the connection manager 312. In selected embodiments, the cluster 200 may be configured such that the VPC 302 and connection manager 312 make read or write requests to a connection ID 1300 as opposed to specifying the real address 1306 in data memory 308 where the read or write is to occur. This allows real addresses 1306 to be generated in a way that is transparent to program code loading or storing data in the data memory 308, thereby simplifying the writing of code for the cluster 200. That is, program code may read and write to connection IDs 1300 as opposed to real addresses 1306 in data memory 308. The address generation unit 310 may be configured to translate the connection IDs 1300 into real addresses 1306.

In certain embodiments, the connection ID 1300 may be composed of both a buffer ID 1302 and a port ID 1304. The buffer ID 1302 and port ID 1304 may correspond to a buffer and port, respectively. In general, the buffer may identify one or more regions in data memory 308 in which to read or write data. The port, on the other hand, may identify an access pattern (such as a FIFO, nested loop, matrix transform, or other access pattern etc.) for reading or writing data to the buffer. Various different types of buffers will be explained in more detail in association with FIGS. 15A through 15D.

In selected embodiments, the connection ID 1300 may be made up of a pre-defined number of bits (e.g., sixteen bits). Accordingly, the buffer ID 1302 and port ID 1304 may use some portion of the pre-defined number of bits. For example, where the connection ID 1300 is sixteen bits, the buffer ID 1302 may make up the lower seven bits of the connection ID 1300 and the port ID 1304 may make up the upper nine bits of the connection ID 1300. This allows for 2⁷ (i.e., 128) buffers and 2⁹ (i.e., 512) ports.

Referring to FIG. 14, in selected embodiments, the address generation unit 310 may include various mechanisms for translating the connection ID 1300 into real addresses 1306. For example, in certain embodiments, the address generation unit 310 may include a buffer descriptor memory 1400 and a port descriptor memory 1402. These memories 1400, 1402 may be two separate memory devices or the same memory device.

In selected embodiments, the buffer descriptor memory 1400 may contain a buffer descriptor table 1404 containing buffer records 1408. In certain embodiments, the buffer records 1408 are indexed by buffer ID 1302, although other indexing methods are also possible. Along with other information, the buffer records 1408 may include a type 1410, which may describe the type of buffer associated with the buffer ID. In selected embodiments, buffer types may include but are not limited to “point-to-point,” “broadcast,” “scatter,” and “gather” buffer types, which will be explained in more detail in association with FIGS. 15A through 15D.

The buffer records 1408 may also store attributes 1412 associated with the buffers. These attributes 1412 may include, among other information, the size of the buffer, a data available indicator (indicating whether data is available that may be read from the buffer), a space available indicator (indicating whether space is available in the buffer to write data), or the like. In selected embodiments, the buffer record 1408 may also include a buffer base address 1414. Using the buffer base address 1414 and an offset 1422 (as will be described in more detail hereafter), the address generation unit 310 may calculate real addresses in the data memory 308 when reading or writing thereto. The address generation unit 310 may generate the real addresses internally, eliminating the need for external code to specify real addresses for reading and writing.

Similarly, in selected embodiments, the port descriptor memory 1402 may store a port descriptor table 1406 containing port records 1416. In certain embodiments, the port records 816 are indexed by port ID 1304. In certain embodiments, the port records 1416 may store a type 1418, which may describe the type of port associated with the port ID 1304. In selected embodiments, port types may include but are not limited to “FIFO,” “matrix transform,” “nested loop,” “end point pattern” (EPP), and “non-recursive pattern” (NRP) port types.

The port records 1416 may also store attributes 1420 of the ports they describe. These attributes 1420 may vary depending on the type of port. For example, attributes 1420 for a “nested loop” port may include, among other information, the number of times the nested loops are repeated, the step size of the loops, the dimensions of the two-dimensional data structure (to support wrapping in each dimension), or the like. Similarly, for an “end point pattern” port, the attributes 1420 may include, among other information, the end points to move between when scanning the vectors in a buffer, the step size between the end points, and the like. Similarly, for a “matrix transform” port, the attributes 1420 may include the matrix that is used to generate real addresses, or the like. The attributes 1420 may also indicate whether the port is a “read” or “write” port.

In general, the attributes 1420 may include the rules or parameters required to advance the offset 1422 as vectors are read from or written to the buffer. The rules may follow either a “FIFO,” “matrix transform,” “nested loop,” “end point pattern” (EPP), or “non-recursive pattern” model, as previously discussed, depending on the type 1418 of port. In short, each of these models may provide different methods for incrementing or decrementing the offset. The offset 1422 may be defined as the distance from the base address 1414 of the buffer where data is read from or written to memory 308 (depending on whether the port is a “read” or “write” port). The offset 1422 may be updated in the port descriptor 1416a when data is read from or written to the data memory 308 using the port ID. The address generation unit 310 may advance and keep track of the offset 1422 internally, making it transparent to the program code performing the load or store instructions.

Referring to FIGS. 15A through 15D, various embodiments of the “point-to-point,” “broadcast,” “scatter,” and “gather” buffers briefly described above are explained in more detail. FIG. 15A is a block diagram showing one example of a “point-to-point” buffer; FIG. 15B is a block diagram showing one example of a “broadcast” buffer; FIG. 15C is a block diagram showing one example of a “scatter” buffer; and FIG. 15D is a block diagram showing one example of a “gather” buffer.

As illustrated in FIG. 15A, a “point-to-point” buffer may be generally defined as a buffer where there is a single producer (associated with a single write port of the buffer 402), and a single consumer (associated with a single read port on the buffer 402) that receives data from the buffer 402. In selected embodiments, the consumer reads the data in the same order in which it was written to the buffer 402. In other embodiments, the consumer reads the data in a different order from which it was written to the buffer 402. For example, the read port of the consumer may be defined as a “FIFO” port, whereas the write port of the producer may be defined as a “nested loop” port. This may cause the consumer to read the data in a different pattern than it was written by the producer.

As shown in FIG. 15B, a “broadcast” buffer may be generally defined as a buffer 402 where each vector that is transferred to the buffer 402 from a single producer (associated with a single write port of the buffer 402) may be broadcast to multiple consumers (each associated with a different read port of the buffer 402). Stated otherwise, each vector that is written to the buffer 402 by a single producer may be consumed by multiple consumers. Nevertheless, in certain cases, although the consumers may read the same data from the same buffer, the consumers may be reading from different parts of the buffer at any given time.

As shown in FIG. 15C, a “scatter buffer” may be generally defined as a buffer 402 in which vectors that are transferred to the buffer 402 by a single producer (associated with a single write port) may be “scattered” for consumption by multiple consumers (each associated with a different read port). In certain embodiments, a scatter buffer may be implemented by establishing several sub-buffers (or subdivisions) within a larger buffer 402. For example, if a producer writes three vectors to the buffer 402, the first vector may be written to a first sub-buffer, the second vector may be written to a second sub-buffer, and the third vector may be written to a third sub-buffer within the buffer 402. Vectors that are written to the first sub-buffer may be consumed by a first consumer, vectors that are written to the second sub-buffer may be consumed by a second consumer, and vectors that are written to the third sub-buffer may be consumed by a third consumer. Thus, this type of buffer 402 enables a producer to “scatter” vectors across various sub-buffers, each of which may be consumed by a different consumer. This is similar to the broadcast buffer except that each vector that is written to the buffer 402 is only consumed by a single consumer as opposed to multiple consumers. Thus, unlike the broadcast buffer, all the consumers do not share the same data.

As shown in FIG. 15D, a “gather” buffer may be generally defined as a buffer in which vectors generated by multiple producers may be gathered together into a single buffer. In certain embodiments, this type of buffer may also be implemented by establishing a number of sub-buffers within a larger buffer. For example, a first producer may be configured to write data to a first sub-buffer within the buffer, a second producer may be configured to write data to a second sub-buffer within the buffer, and a third producer may be configured to write data to a third sub-buffer within the buffer. A single consumer may be configured to consume the data produced by the multiple producers. In this way, data generated by multiple producers may be “gathered” together so that it may be consumed by a single or smaller number of consumers.

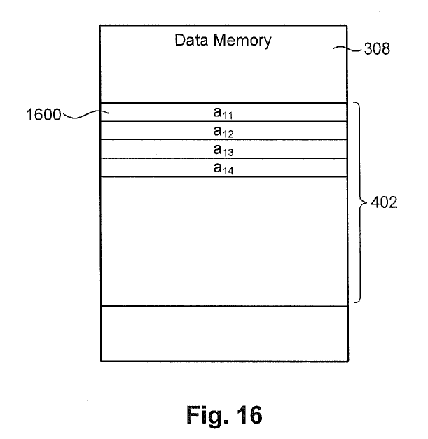

Referring to FIG. 16, as previously mentioned, a buffer 402 may identify one or more regions in data memory 308 in which to read or write data. A buffer 402 may store vectors 1600 (herein shown as vectors a₁₁, a₁₂, a₁₃, a₁₄) with each vector 1600 storing a defined number (e.g., sixteen) of elements, and each element storing a defined number (e.g., sixteen) of bits. The number of elements in each vector may be equal to the number of processing elements in the VPU array 300.

In selected applications, the buffer 402 may be used to store a multi-dimensional data structure, such as a two-dimensional data structure (e.g., two-dimensional video data). The VPU array 300 may operate on the multi-dimensional data structure. In such an embodiment, each of the vectors 1600 may represent some portion of the multi-dimensional data structure. For example, where the multi-dimensional data structure is a two-dimensional data structure, each of the vectors 1600 may represent a 4×4 block of pixels (sixteen pixels total), where each element of a vector 1600 represents a pixel within the 4×4 block.

The invention may be embodied in other specific forms without departing from its spirit or essential characteristics. The described examples are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method for transferring data between buffers within a data processing architecture, the method comprising:
providing first and second memory devices within a data processing architecture;
providing a first connection manager, associated with a first buffer in the first memory device, and a second connection manager associated with a second buffer in the second memory device, the first and second connection managers managing data transfers between the first and second buffers;
receiving, by the first connection manager, a token from the second connection manager to trigger data transfer between the first buffer and the second buffer; and
initiating, by the first connection manager, a data transfer between the first and second buffers in response to receiving the token.

2. The method of claim 1, wherein initiating a data transfer comprises transmitting data from the second buffer to the first buffer if the token indicates that data is available in the second buffer.

3. The method of claim 2, wherein initiating a data transfer comprises pulling data by the first connection manager from the second connection manager.

4. The method of claim 1, wherein initiating a data transfer comprises transmitting data from the first buffer to the second buffer if the token indicates that space is available in the second buffer.

5. The method of claim 4, wherein initiating a data transfer comprises pushing data by the first connection manager to the second connection manager.

6. The method of claim 1, wherein initiating a data transfer comprises transmitting a block of data vectors.

7. The method of claim 6, wherein transmitting a block of data vectors further comprises reading a block descriptor designating the size of the block.

8. The method of claim 1, further comprising calculating effective addresses in the first buffer with a first address generation unit, associated with the first connection manager, and calculating effective addresses in the second buffer with a second address generation unit, associated with the second connection manager.

9. The method of claim 8, wherein the first and second connection managers are unaware of the effective addresses.

10. The method of claim 1, wherein the first and second connection managers are configured to initiate data transfers therebetween without CPU intervention.

11. An apparatus for transferring data between buffers within a data processing architecture, the apparatus comprising:
first and second memory devices within a data processing architecture;
a first connection manager, associated with a first buffer within the first memory device, and a second connection manager associated with a second buffer within the second memory device, the first and second connection managers managing data transfers between the first and second buffers;
the first connection manager further configured to receive a token from the second connection manager indicating that at least one of data and space is available in the second buffer; and
the first connection manager further configured to initiate data transfer between the first and second buffers in response to receiving the token.

12. The apparatus of claim 11, wherein the first connection manager is configured to pull data from the second connection manager if the token indicates that data is available in the second buffer.

13. The apparatus of claim 11, wherein the first connection manager is configured to push data to the second connection manager if the token indicates that space is available in the second buffer.

14. The method of claim 11, wherein the first connection manager is configured to transmit a block of data vectors in response to receiving the token.

15. The apparatus of claim 14, wherein the first connection manager is further configured to read a block descriptor designating the size of the block.

16. The apparatus of claim 11, further comprising a first address generation unit, associated with the first connection manager, to calculate effective addresses in the first buffer, and a second address generation unit, associated with the second connection manager, to calculate effective addresses in the second buffer.

17. The apparatus of claim 16, wherein the first and second connection managers are unaware of the effective addresses.

18. The apparatus of claim 11, wherein the first and second connection managers are configured to initiate data transfers therebetween without CPU intervention.

19. An apparatus for transferring data between buffers within a data processing architecture, the apparatus comprising:
first and second memory devices within a data processing architecture;
a first connection manager, associated with a first buffer within the first memory device, and a second connection manager associated with a second buffer within the second memory device, the first and second connection managers managing data transfers between the first and second buffers;
a first address generation unit, associated with the first connection manager, to calculate effective addresses in the first buffer, and a second address generation unit, associated with the second connection manager, to calculate effective addresses in the second buffer, the first and second connection managers being unaware of the effective addresses.

20. The apparatus of claim 19, wherein the first connection manager is configured to receive a token from the second connection manager indicating that at least one of data and space is available in the second buffer.

21. The apparatus of claim 20, the first connection manager further configured to initiate data transfer between the first and second elements in response to receiving the token.

22. The method of claim 19, wherein the first and second connection managers are configured to transmit blocks of data vectors therebetween.

23. The apparatus of claim 22, wherein the first and second connection managers are configured to read block descriptors designating the size of the blocks.

24. The apparatus of claim 19, wherein the first and second connection managers are configured to initiate data transfers therebetween without CPU intervention.
